(19) United States
(12) Patent Application Publication
(10) Pub. No.: US 2007/0177664 A1
(43) Pub. Date: Aug. 2, 2007

(54) Entropy encoding/decoding method and apparatus

(75) Inventor: Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/655,218

(22) Filed: Jan. 19, 2007

Related U.S. Application Data
(60) Provisional application No. 60/759,971, filed on Jan. 19, 2006.

(30) Foreign Application Priority Data
Dec. 28, 2006 (KR) 10-2006-136770

(51) Int. Cl. H04B 1/66; H04N 7/12

(52) U.S. Cl. 375/240.1; 375/240.26

(57) ABSTRACT

Provided is a method and apparatus for enhancing the efficiency of entropy-coding a fine granular scalability (FGS) layer. The method of entropy-encoding current coefficients included in a predetermined one of a plurality of separate quality layers includes reading coefficients of lower layers, which correspond to the current coefficients; grouping the current coefficients according to a combination of the coefficients of the lower layers; and encoding each group of the current coefficients using a different context model.

### CROSS-REFERENCE TO RELATED APPLICATION

This application and claims priority from Korean Patent Application No. 10-2006-0136770 filed on Dec. 28, 2006, in the Korean Intellectual Property Office, and U.S. Provisional Patent Application No. 60/759,971 filed on Jan. 19, 2006 in the United States Patent and Trademark Office, the disclosures of which are entirely incorporated herein by reference.

### BACKGROUND OF THE INVENTION

1. Field of the Invention

Methods and apparatuses consistent with the present invention relate to video compression technology, and more particularly, to enhancing the efficiency of entropy-coding a fine granular scalability (FGS) layer.

2. Description of the Related Art

The development of information and communication technology (ICT) including the Internet has increased video communication as well as text and voice communication. As conventional text-oriented communication fails to satisfy various needs of users, multimedia services, which can provide various types of information such as text, images and music, have increased. Due to its large size, multimedia data requires a large-capacity storage medium. In addition, a wide bandwidth is required to transmit the multimedia data. Therefore, a compression coding method is a requisite for transmitting multimedia data including text, images, and audio.

A basic principle of data compression lies in removing data redundancy. That is, data can be compressed by removing spatial redundancy which has to do with repetition of the same color or object in an image, temporal redundancy which occurs when there is little change between adjacent frames in a moving-image frame or when the same sound repeats in audio, or psychological visual redundancy which takes into consideration insensitivity of human eyesight and perception to high frequency. In a conventional video coding method, temporal filtering based on motion compensation is used to remove temporal redundancy, and a spatial transform is used to remove spatial redundancy.

The result of removing data redundancy is lossy-coded through a predetermined quantization process. Then, the quantization result is finally losslessly coded through an entropy coding process.

A Joint Video Team, which is a video experts group of the International Organization for Standardization (ISO)/the International Electrotechnical Commission (IEC) and the International Telecommunication Union (ITU), is currently working on a scalable video coding (SVC) standard. In the SVC standard, multilayer-based coding technology, which is based on conventional H.264 standard, is being actively studied. In particular, the SVC standard adopts fine granular scalability (FGS) technology to gradually enhance quality or bitrate of one frame.

FIG. 1 is a conceptual diagram illustrating a plurality of quality layers that form a frame or slice 10 (hereinafter, referred to only as “the slice”). A quality layer is defined as data recorded in one of sub-slices in order to support signal-to-noise ratio (SNR) scalability. A major example of the quality layer is an FGS layer, but is not limited thereto. The quality layers may be divided into a discrete layer 14 and first through third FGS layers 11 through 13. Video quality measured by a video decoder improves in order of when only the discrete layer 14 is received, when the discrete layer 14 and the first FGS layer 13 are received, when the first and second FGS layers 13 and 12 are received, and when all of the layers 11 through 14 are received.

In the SVC standard, coding is performed using relations between FGS layers. That is, a coefficient of an FGS layer is coded using corresponding coefficients of other FGS layers according to a divided coding pass (a significant pass or a refinement pass). In this case, a coefficient of a current layer is coded using the significant pass if all corresponding coefficients of its lower layers are zero. If any one of the coefficients of the lower layers is not zero, the coefficient of the current layer is coded using the refinement pass. As described above, a coefficient of an FGS layer is coded using different passes since the probability distribution of the coefficient distinctly varies according to corresponding coefficients of its lower layers.

A document (Multiple FGS Layer Coding for Low-Delay Applications, 18th Meeting: Bangkok, Thailand, 14-20 Jan., 2006, hereinafter referred to as “JVT-R077”) produced by Nokia in relation to the SVC standard suggests a dual loop structure suitable for a decoder. A conventional multi-loop coding method requires motion compensation for each FGS layer, thereby increasing calculation complexity. In order to reduce calculation complexity, JVT-R077 suggests the dual loop structure suitable for a decoder. That is, in the dual loop structure, an encoder performs conventional multi-loop coding, and a decoder performs dual-loop coding. However, it is known that partial decoding performance of dual loop coding suggested in JVT-R077 is significantly lower than that of multi-loop coding. To solve this problem, JVT-R077 suggests a change in an FGS entropy coding order.

FIG. 2 illustrates a coding order suggested in JVT-R077. According to JVT-R077, a coefficient cₙ of a second FGS layer when a coefficient of a discrete layer is not zero and a coefficient of a first FGS layer is zero is coded first in a scanning order. Then, the remaining coefficients cₙ₊₁ through cₙ₊₃ of the second FGS layer are coded in the scanning order. Here, a first context model Ctx₁ is applied to the coefficient cₙ, and a second context model Ctx₂, which is different from the first context model Ctx₁, is applied to the remaining coefficients cₙ₊₁, through cₙ₊₃.

However, dividing the coding order into first and second coding orders is still not adequate to efficiently code the coefficients cₙ through cₙ₊₃ of the second FGS layer since there is also a clear difference in probability distribution between the remaining coefficients cₙ₊₁ through cₙ₊₃. For example, the probability distribution of the coefficients cₙ through cₙ₊₃ of the second FGS layer is different when all coefficients of its lower layers, i.e., the first FGS layer and the discrete layer, are zero and when the coefficient of the first FGS layer is not zero while the coefficient of the discrete layer is zero. Therefore, it is required to code the coefficients cₙ through cₙ₊₃ of the second (or higher) FGS layer according to a smaller combination of the coefficients of its lower layers.

### SUMMARY OF THE INVENTION

Aspects of the present invention provide a method and apparatus which can enhance the efficiency of entropy-coding video data that is composed of a plurality of quality layers.

According to an aspect of the present invention, there is provided a method of entropy-encoding current coefficients included in a predetermined one of a plurality of separate quality layers. The method includes reading coefficients of lower layers, which correspond to the current coefficients; grouping the current coefficients according to a combination of the coefficients of the lower layers; and encoding each group of the current coefficients using a different context model.

According to another aspect of the present invention, there is provided a method of entropy-decoding encoded current coefficients included in a predetermined one of a plurality of separate quality layers. The method includes reading coefficients of lower layers, which correspond to the encoded current coefficients; selecting a context model for the encoded current coefficients according to a combination of the coefficients of the lower layers; and decoding each group of the encoded current coefficients using the selected context model.

According to another aspect of the present invention, there is provided an apparatus for entropy-encoding current coefficients included in a predetermined one of a plurality of separate quality layers. The apparatus includes a reading unit reading coefficients of lower layers, which correspond to the current coefficients; a grouping unit grouping the current coefficients according to a combination of the coefficients of the lower layers; and an encoding unit encoding each group of the current coefficients using a different context model.

According to another aspect of the present invention, there is provided an apparatus for entropy-decoding encoded current coefficients included in a predetermined one of a plurality of separate quality layers. The apparatus includes a reading unit reading coefficients of lower layers, which correspond to the encoded current coefficients; a selection unit selecting a context model for the encoded current coefficients according to a combination of the coefficients of the lower layers; and a decoding unit decoding each group of the encoded current coefficients using the selected context model.

### BRIEF DESCRIPTION OF THE DRAWINGS

The above and other aspects and features of the present invention will become more apparent by describing in detail exemplary embodiments thereof with reference to the attached drawings, in which:

FIG. 1 is a conceptual diagram illustrating a plurality of quality layers that form a slice;

FIG. 2 illustrates a coding order suggested in JVT-R077;

FIG. 3 illustrates a method of coding coefficients of a second fine granular scalability (FGS) layer according to an exemplary embodiment of the present invention;

FIG. 4 is a diagram for explaining the meaning of corresponding coefficients;

FIG. 5 illustrates an example of scanning coefficients, which are included in a block of a second FGS layer, in a zigzag scanning order;

FIG. 6 is a block diagram of a video encoder according to an exemplary embodiment of the present invention;

FIG. 7 is a detailed block diagram of an entropy encoding unit included in the video encoder of FIG. 6;

FIG. 8 is a block diagram of a video decoder according to an exemplary embodiment of the present invention;

FIG. 9 is a detailed block diagram of an entropy decoding unit included in the video decoder of FIG. 8;

FIG. 10 illustrates a process of filling a current quality layer with coefficients using a degrouping unit included in the entropy decoding unit of FIG. 9;

FIG. 11 is a flowchart illustrating a video encoding method including an entropy encoding method according to an exemplary embodiment of the present invention; and

FIG. 12 is a flowchart illustrating a video decoding method including an entropy decoding method according to an exemplary embodiment of the present invention.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and thus their description will be omitted.

Exemplary embodiments of the present invention will hereinafter be described in detail with reference to the accompanying drawings.

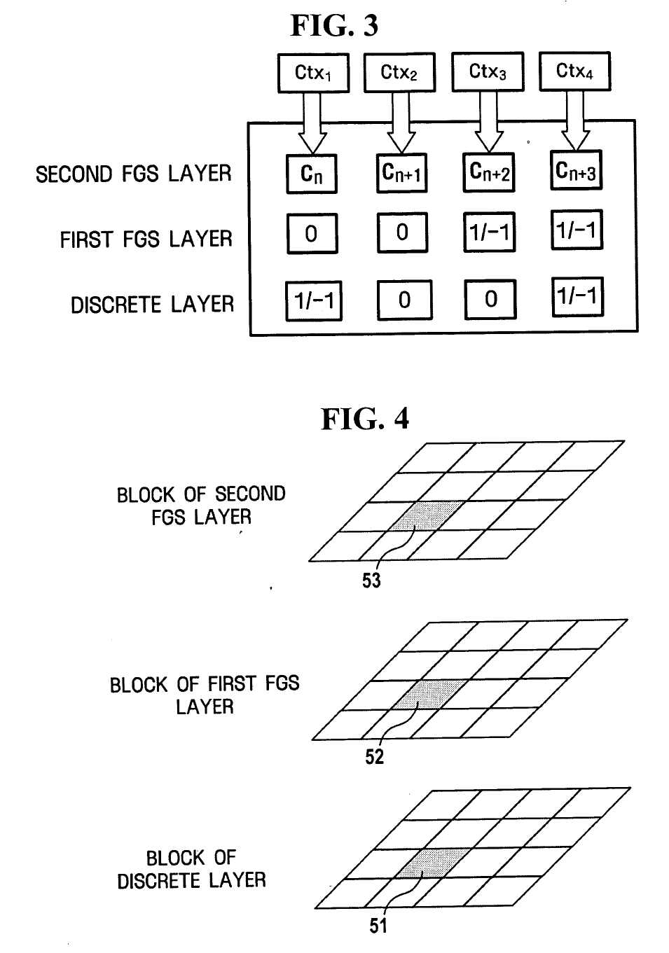

FIG. 3 illustrates a method of coding coefficients of a second fine granular scalability (FGS) layer according to an exemplary embodiment of the present invention. Referring to FIG. 3, a coding order of the coefficients of the second FGS layer is determined according to a combination of corresponding coefficients of its lower layers. A context adaptive binary arithmetic coding (CABAC) or context adaptive variable length coding (CAVLC) algorithm may be applied to each combination of the coefficients of the second FGS layer in the coding order. Therefore, it can be understood that a context model or a variable length coding (VLC) table is determined according to the coding order. Various algorithms, such as the CABAC and CAVLC algorithms, may be used as a method of coding the second FGS layer. However, the following descriptions will be made based on the CABAC algorithm which is currently adopted by a scalable video coding (SVC) standard.

For example, a total of four cases may occur according to whether a coefficient of a discrete layer and that of a first FGS layer are zero, and different context models may be applied to the four cases. The coefficients of the second FGS layer may be coded based on a corresponding context model and according to the CABAC algorithm.

Here, “corresponding coefficients” denote coefficients located at the same spatial positions in a plurality of quality layers. For example, if a 4×4 block is represented by a discrete layer, a first FGS layer, and a second FGS layer as illustrated in FIG. 4, lower coefficients (coefficients of lower layers) corresponding to a coefficient 53 of the second FGS layer are a coefficient 52 of the first FGS layer and a coefficient 51 of the discrete layer.

In the embodiment of FIG. 3, the coefficients of the second FGS layer are divided into four groups in view of the fact that the probability distribution of the coefficients of the second FGS layer significantly varies according to whether the coefficients of its lower layers are zero. Whether the coefficients of the lower layers are zero is certainly an important standard for dividing the coefficients of the second FGS layer. However, the standard may further be divided according to signs of non-zero coefficients. That is, since a corresponding coefficient of each of the first FGS layer and the discrete layer can have a value of 0, 1, or −1, there could be nine cases. Accordingly, the coefficients of the second FGS layer may be divided into nine groups. A different context model may be applied to each group. Also, the coefficients of the second FGS layer may be losslessly encoded based on a corresponding context model and according to the CABAC algorithm.

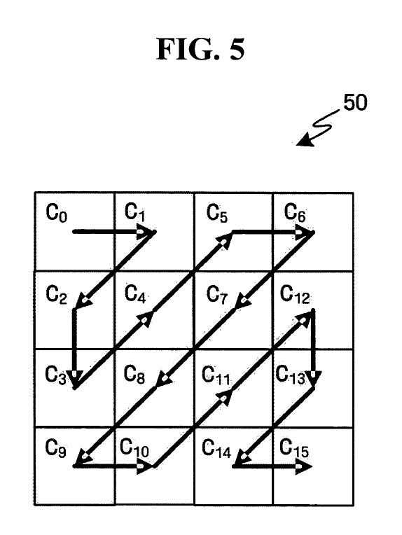

FIG. 5 illustrates an example of scanning coefficients c₀ through c₁₅, which are included in a block 50 of a second FGS layer, in a zigzag scanning order. In an exemplary embodiment of the present invention, a coding order of groups, into which the coefficients c₀ through c₁₅ have been divided according to a combination of coefficients of lower layers, is set. Then, while the coefficients c₀ through c₁₅ are scanned, coefficients, which come first in the coding order, are grouped and coded using the CABAC algorithm. Similarly, while the coefficients c₀ through c₁₅ are scanned, coefficients, which come next in the coding order, are grouped and coded using the CABAC algorithm. This process is repeated until coefficients, which come last in the coding order, are grouped and encoded.

However, it may be inefficient to scan the block 50 of the second FGS layer whenever each group of coefficients is coded in the coding order. Therefore, in another embodiment of the present invention, while the coefficients c₀ through c₁₅ are scanned regardless of the coding order, they may be classified into a plurality of groups according to a combination of the coefficients of the lower layers, and each group may be coded using the CABAC algorithm.

The two exemplary embodiments are identical in that the CABAC algorithm is applied to each group of coefficients, i.e., a different context model is applied to each group of coefficients.

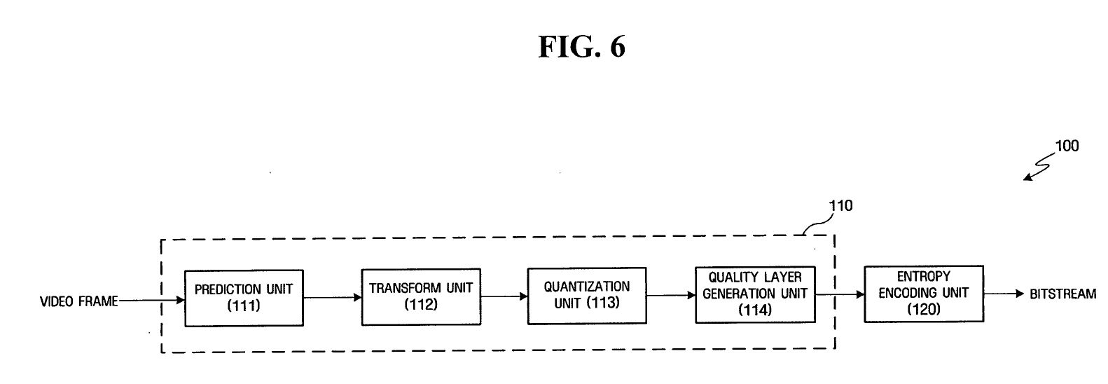

FIGS. 6 through 9 illustrate the configurations of a video encoder and a video decoder using an entropy coding method according to the present invention.

Specifically, FIG. 6 is a block diagram of a video encoder 100 according to an exemplary embodiment of the present invention. The video encoder 100 may include a frame encoding unit 110 and an entropy encoding unit 120.

The frame encoding unit 110 generates one or more quality layers from an input video frame.

To this end, the frame encoding unit 110 may include a prediction unit 111, a transform unit 112, a quantization unit 113, and a quality layer generation unit 114.

The prediction unit 111 subtracts an image, which was predicted using a predetermined prediction method, from a current macroblock and obtains a residual signal. The prediction method may be one of prediction methods disclosed in an SVC draft, such as inter prediction, directional intra prediction, and intra base prediction. Inter prediction may include a motion estimation process for obtaining a motion vector that represents a relative motion between a current frame and a frame having the same resolution as the current frame and existing at a different temporal position from the current frame. The current frame may be predicted by referring to a frame of a lower layer (base layer) which exists at the same temporal position and has a different resolution from the current frame. This is called intra base prediction. In intra base prediction, the motion estimation process is unnecessary.

The transform unit 112 transforms the obtained residual signal using a spatial transform method, such as a discrete cosine transform (DCT) and a wavelet transform, and generates a transform coefficient. The spatial transform method may be the DCT or the wavelet transform. After the spatial transform, the transform coefficient is obtained. When the DCT is used as the spatial transform method, a DCT coefficient is generated. When the wavelet transform is used, a wavelet coefficient is generated.

The quantization unit 113 quantizes the transform coefficient generated by the transform unit 112 and generates a quantization coefficient. Quantization is a process of dividing the transform coefficient represented by a real number into sections represented by discrete values. A quantization method used here may be scalar quantization or vector quantization.

The quality layer generation unit 114 generates a plurality of quality layers using a conventional FGS method. The quality layers may include a discrete layer and one or more FGS layers. The discrete layer can be encoded/decoded independently. However, each of the FGS layers is encoded/decoded by referring to other layers.

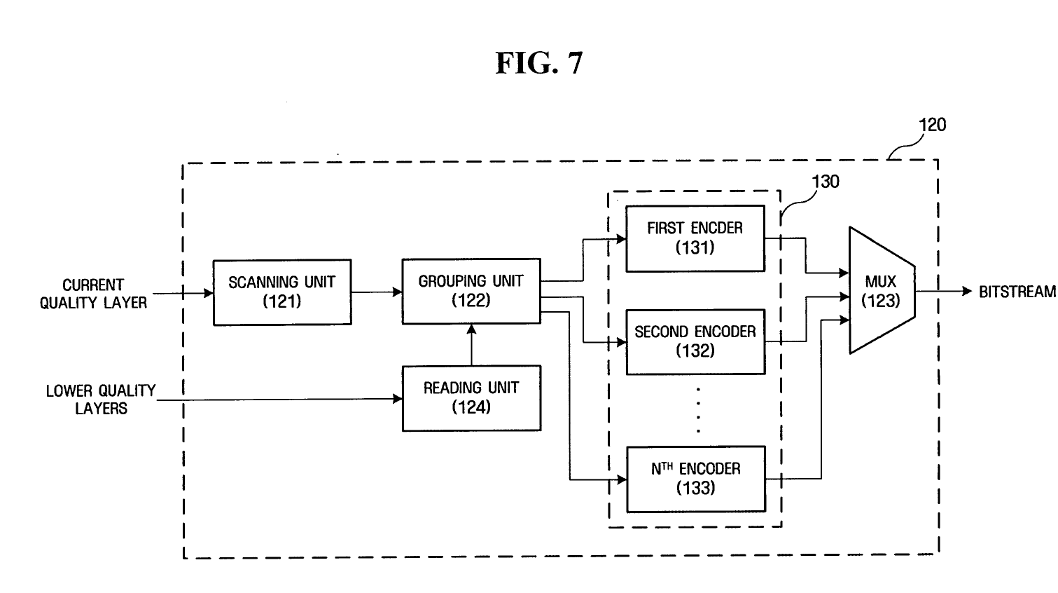

The entropy encoding unit 120 performs entropy encoding according to an exemplary embodiment of the present invention. A detailed configuration of the entropy encoding unit 120 is illustrated in FIG. 7. Referring to FIG. 7, the entropy encoding unit 120 may include a scanning unit 121, a grouping unit 122, an encoding unit 130, a multiplexer 123, and a reading unit 124.

The reading unit 124 reads coefficients of lower layers, which correspond to coefficients (current coefficients) included in a block of a current quality layer (a second or higher FGS layer).

The scanning unit 121 scans the current coefficients using a predetermined scanning method (such as a zigzag scanning or raster scanning method).

The grouping unit 122 groups the scanned current coefficients according to a combination of the coefficients of the lower layers, which correspond to the scanned current coefficients. Here, a coding order may be allocated to each combination of the coefficients of the lower layers, and the current coefficients may be grouped while all blocks included in a slice or frame are repeatedly (as many as the number of the combinations) scanned in the allocated coding order. Alternatively, the current coefficients may be classified and grouped according to each combination of the coefficients of the lower layers while the blocks are scanned only once regardless of the coding order.

The encoding unit 130 losslessly encodes each group of the current coefficients grouped by the grouping unit 122. The encoding unit 130 may include an equal number of encoders 131 through 133 to the number (n) of groups that it is responsible for. If the CABAC algorithm was used as the lossless encoding method, each of the encoders 131 through 133 generates a context model for a corresponding group of coefficients and encodes the coefficients using the CABAC algorithm.

The CABAC algorithm is well known as a method of selecting a probability model for coefficients to be coded and arithmetically coding the coefficients. Generally, the CABAC algorithm is composed of binarization, context model selection, arithmetic coding, and probability update processes.

The multiplexer 123 multiplexes each group of data encoded by the encoding unit 130 and outputs a bitstream.

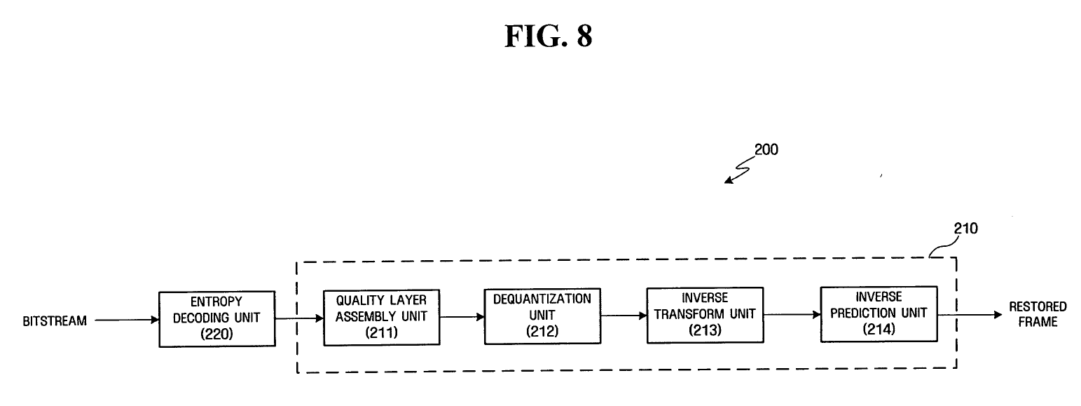

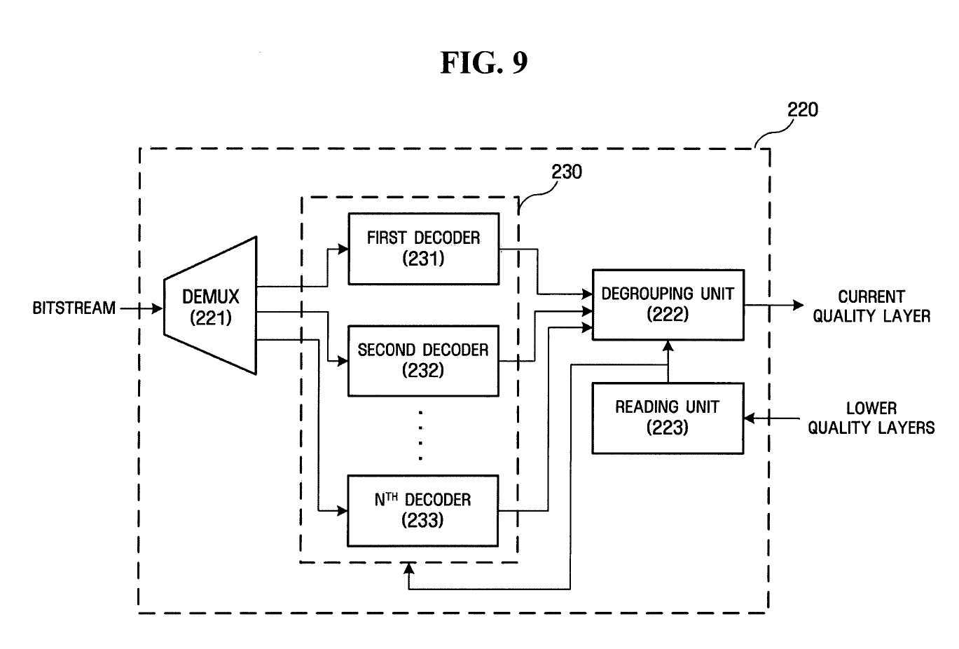

FIG. 8 is a block diagram of a video decoder 200 according to an exemplary embodiment of the present invention. The video decoder 200 includes an entropy decoding unit 220 and a frame decoding unit 210. The entropy decoding unit 220 performs entropy decoding according to an exemplary embodiment of the present invention on coefficients of a block of a current quality layer among one or more quality layers of an input bitstream. A detailed configuration of the entropy decoding unit 220 is illustrated in FIG. 9.

The frame decoding unit 210 restores an image of the block from the coefficients of the block losslessly decoded by the entropy decoding unit 220. To this end, the frame decoding unit 210 includes a quality layer assembly unit 211, a dequantization unit 212, an inverse transform unit 213, and an inverse prediction unit 214.

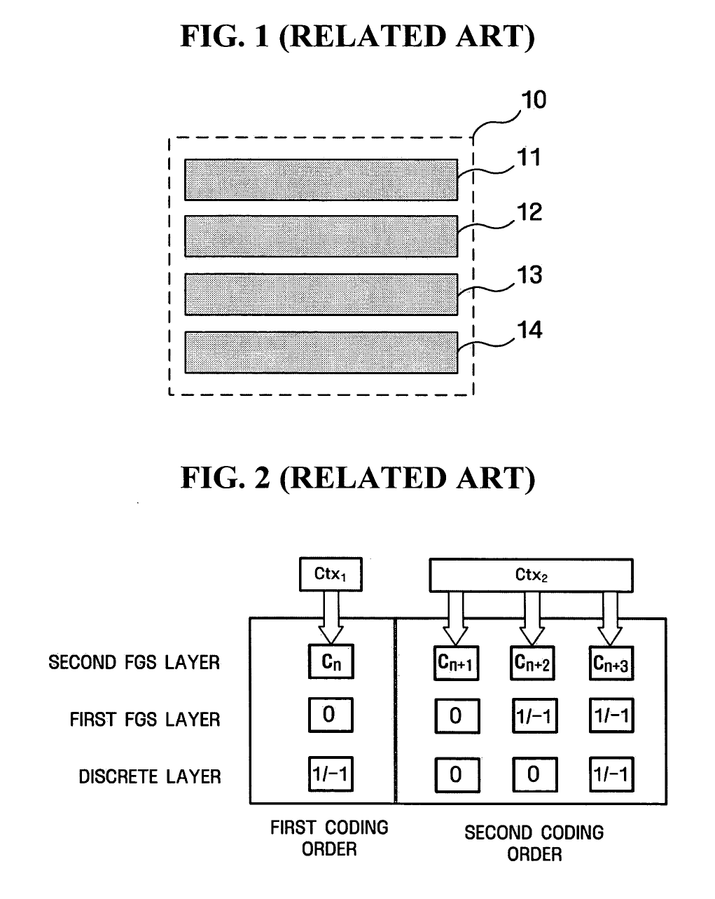

The quality layer assembly unit 211 adds a plurality of quality layers such as those illustrated in FIG. 1 and generates a piece of slice data or frame data.

The dequantization unit 212 dequantizes data provided by the quality layer assembly unit 211.

The inverse transform unit 213 inversely transforms the dequantization result. This inverse transform is a reverse process of the transform performed by the transform unit 112 of FIG. 6.

The inverse prediction unit 214 adds a restored residual signal provided by the inverse transform unit 213 to a prediction signal and restores a video frame. As in the video encoder 100, the prediction signal may be obtained by inter prediction or intra base prediction.

FIG. 9 is a detailed block diagram of the entropy decoding unit 220. The entropy decoding unit 220 may include a demultiplexer 221, a decoding unit 230, and a degrouping unit 222, and a reading unit 223.

The demultiplexer 221 demultiplexes a bitstream and provides each group of encoded coefficients of a current quality layer (encoded current coefficients) to the decoding unit 230.

The decoding unit 230 may include an equal number of decoders 231 through 233 to the number (n) of groups that it is responsible for. If the CABAC algorithm was used as the lossless encoding method, each of the decoders 231 through 233 decodes a corresponding group of the encoded current coefficients in a reverse process of the CABAC algorithm. That is, the decoding unit 230 selects a context model for the encoded current coefficients according to a combination of corresponding coefficients of lower layers and decodes the current coefficients using the selected context model.

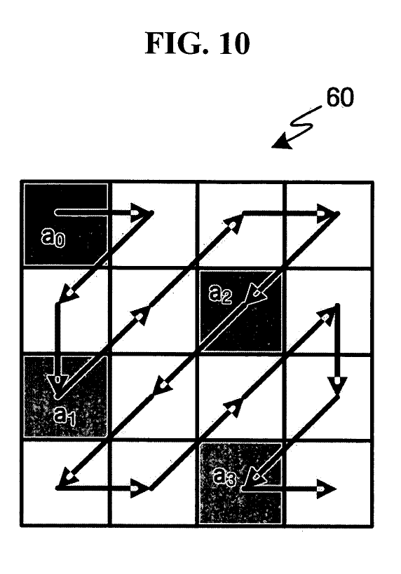

The degrouping unit 222 fills the block of the current quality layer with the current coefficients, which were decoded by the decoding unit 230, according to a combination of the coefficients of the lower layers which correspond to the decoded current coefficients. This degrouping process is a reverse process of the grouping process performed by the grouping unit 122 of FIG. 7. That is, the degrouping unit 222 fills a position of the block of the current layer, which corresponds to a combination of coefficients of lower layers, with restored coefficients of a particular group. Here, the filling order is the same as the scanning order of the video encoder 100. For example, referring to FIG. 10, a₀ through a₃ may indicate coefficients included in a group that corresponds to a particular combination of coefficients of lower layers. In this case, it is required to check whether the coefficients of the lower layers form the particular combination while scanning a block 60 of a current quality layer in the scanning order in order to fill the block 60 with the coefficients a₀ through a₃. If it is determined that the coefficients of the lower layers form the particular combination, the block 60 is filled with the coefficients a₀ through a₃. If it is determined that the coefficients of the lower layers do not form the particular combination, a next position is processed. In this way, the process of filling the block 60 of the current quality layer with coefficients is repeatedly performed on all groups.

In another embodiment of the present invention, a simpler degrouping algorithm may be used. That is, while the block 60 of the current quality layer is scanned, if a combination of coefficients of lower layers is identified at a certain position of the block 60, coefficients may be fetched from a corresponding group, and the position may be filled with the coefficients. According to this degrouping algorithm, it is not necessary to repeat the scanning process and the process of checking a combination of coefficients of lower layers.

Until now, a case where efficient entropy encoding/decoding suggested by the present invention is applied to a second FGS layer has been described. However, it may be fully understood by those of ordinary skill in the art that the efficient entropy encoding/decoding can also be applied to a higher FGS layer.

Each component described above with reference to FIGS. 6 through 9 may be implemented as a software component, such as a task, a class, a subroutine, a process, an object, an execution thread or a program performed in a predetermined region of a memory, or a hardware component, such as a Field Programmable Gate Array (FPGA) or Application Specific Integrated Circuit (ASIC). In addition, the components may be composed of a combination of the software and hardware components. The components may be reside on a computer-readable storage medium or may be distributed over a plurality of computers.

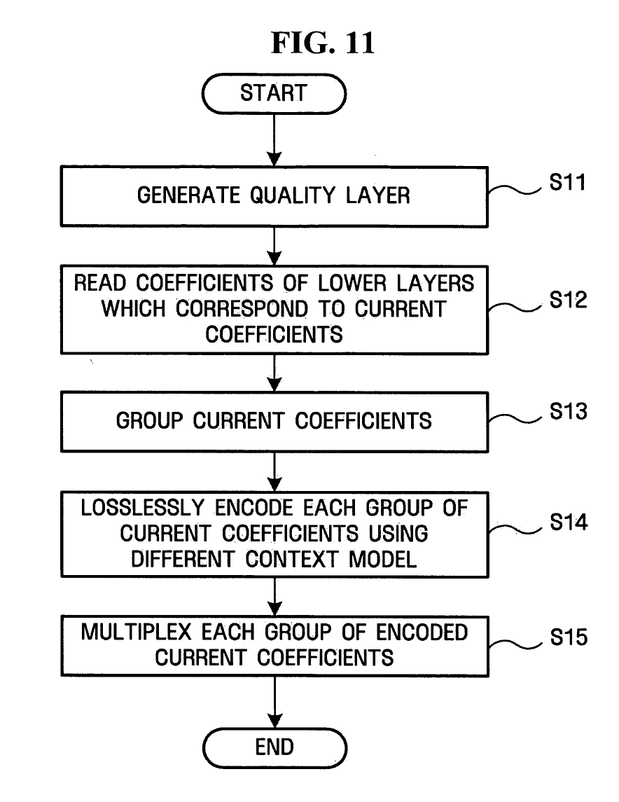

FIG. 11 is a flowchart illustrating a video encoding method including an entropy encoding method according to an exemplary embodiment of the present invention.

First of all, the frame encoding unit 110 generates one or more quality layers from an input video frame (operation S11).

Next, the reading unit 124 reads coefficients of lower layers, which correspond to current coefficients (operation S12). The quality layers include a discrete layer and two FGS layers.

Then, the grouping unit 122 groups the current coefficients according to a combination of the coefficients of the lower layers (operation S13). The combination of the coefficients of the lower layers may be a combination of zero and non-zero values. More specifically, the combination may be a combination of zero, positive, and negative values.

The encoding unit 130 encodes each group of current coefficients using a different context model (operation S14). Here, an encoding algorithm, such as the CABAC or CAVLC algorithm, is used.

Finally, the multiplexer 123 multiplexes each of the encoded current coefficients and outputs a bitstream (operation S15).

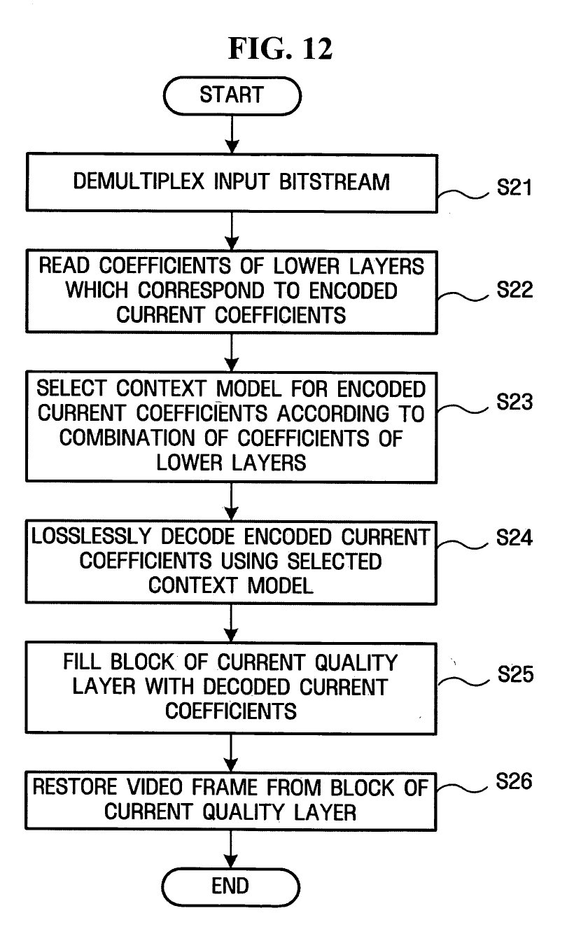

FIG. 12 is a flowchart illustrating a video decoding method including an entropy decoding method according to an exemplary embodiment of the present invention.

First of all, the demultiplexer 221 demultiplexes an input bitstream and provides each group of encoded coefficients of a current quality layer (encoded current coefficients) to the decoding unit 230 (operation S21).

The reading unit 223 reads coefficients of lower layers, which correspond to the encoded current coefficients, and provides the read coefficients of the lower layers to the decoding unit 230 and the degrouping unit 222 (operation S22).

The decoding unit 230 selects a context model for each group of the encoded current coefficients according to a combination of the coefficients of the lower layers (operation S23). Then, the decoding unit 230 decodes the encoded current coefficients using the selected context model (operation S24).

The degrouping unit 222 fills a block of the current quality layer with the decoded current coefficients according to a combination of the coefficients of the lower layers (operation S25).

Finally, the frame decoding unit 210 restores a video frame from the block of the current quality layer (operation S26).

According to the present invention, the efficiency of entropy-encoding video data, which is composed of a plurality of quality layers, can be enhanced.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation.

What is claimed is:

1. A method of entropy-encoding current coefficients included in a predetermined quality layer of a plurality of quality layers, the method comprising:
reading coefficients of lower layers, which correspond to the current coefficients;
grouping the current coefficients according to a combination of the coefficients of the lower layers; and
encoding each group of the current coefficients using a different context model.

2. The method of claim 1, wherein the predetermined quality layer is a second layer or a higher fine granular scalability (FGS) layer.

3. The method of claim 1, wherein an encoding algorithm used in the encoding of each group of the current coefficients is a context adaptive binary arithmetic coding (CABAC) algorithm.

4. The method of claim 3, wherein the CABAC algorithm comprises a binarization process, a context model selection process, an arithmetic coding process, and a probability update process.

5. The method of claim 1, wherein the combination of the coefficients of the lower layers comprises a combination of zero values and non-zero values.

6. The method of claim 1, wherein the combination of the coefficients of the lower layers comprises a combination of zero values, positive values, and negative values.

7. The method of claim 1, wherein the grouping of the current coefficients is performed in a scanning order of a block that contains the current coefficients.

8. A method of entropy-decoding encoded current coefficients included in a predetermined quality layer of a plurality of quality layers, the method comprising:
reading coefficients of lower layers, which correspond to the encoded current coefficients;
selecting a context model for the encoded current coefficients according to a combination of the coefficients of the lower layers; and
decoding each group of the encoded current coefficients using the selected context model to generate decoded current coefficients.

9. The method of claim 8, further comprising filling a block of a current quality layer with the decoded current coefficients according to the combination of the coefficients of the lower layers.

10. The method of claim 8, wherein the predetermined quality layer is a second layer or a higher fine granular scalability (FGS) layer.

11. The method of claim 8, wherein a decoding algorithm used in the decoding of each group of the encoded current coefficients is a decoding algorithm that corresponds to a context adaptive binary arithmetic coding (CABAC).

12. The method of claim 8, wherein the combination of the coefficients of the lower layers comprises a combination of zero values and non-zero values.

13. The method of claim 8, wherein the combination of the coefficients of the lower layers comprises a combination of zero values, positive values, and negative values.

14. An apparatus for entropy-encoding current coefficients included in a predetermined quality layer of a plurality of quality layers, the apparatus comprising:
a reading unit which reads coefficients of lower layers, which correspond to the current coefficients;
a grouping unit which groups the current coefficients according to a combination of the coefficients of the lower layers; and
an encoding unit which encodes each group of the current coefficients using a different context model.

15. An apparatus for entropy-decoding encoded current coefficients included in a predetermined quality layer of a plurality of quality layers, the apparatus comprising:
a reading unit which reads coefficients of lower layers, which correspond to the encoded current coefficients;
a selection unit which selects a context model for the encoded current coefficients according to a combination of the coefficients of the lower layers; and
a decoding unit which decodes each group of the encoded current coefficients using the selected context model.
